(19) United States
(12) Patent Application Publication
(10) Pub. No.: US 2003/0083927 A1
(43) Pub. Date: May 1, 2003

(54) America's political communication system

(76) Inventor: Bruce E. Jaynes, Mt. Vernon, OH (US)

Correspondence Address: JEFFREY FURR, 253 N. MAIN STREET, JOHNSTOWN, OH, 43031, US

(21) Appl. No.: 10/288,939

(22) Filed: Nov. 6, 2002

Related U.S. Application Data
(63) Continuation-in-part of application No. 09/268,568, filed on Mar. 15, 1999, now abandoned.

(51) Int. Cl. G06F 17/60

(52) U.S. Cl. 705/10

(57) ABSTRACT

America's Political Communication System allows direct communication between people and businesses, nonprofit organizations and elected officials through the use of an interactive computer network system. These people would be able to send communications and/or data to the elected official. These communications can be in a preexisting format such as a survey. The American's Political Communication System has a data filter that would protect an individual's identify. The elected official would be able to send messages or questions to her/his voters electronically. This system would give voters equal access to their elected officials that is not based on money. This system would also allow people, businesses, nonprofit organizations and elected officials to store their data electronically which can be retrieved or forward to the appropriate party.

### CROSS-REFERENCES TO RELATED APPLICATIONS (IF ANY)

None

### STATEMENT AS TO RIGHTS TO INVENTIONS MADE UNDER FEDERALLY-SPONSORED RESEARCH AND DEVELOPMENT (IF ANY)

None

### BACKGROUND OF THE INVENTION

There exists different means for which people can communicate with their elected officials. Most of these methods are inefficient and do not allow communication back from the official to the people. The existing systems are cumbersome and have slow turnaround. The existing systems has unequal access, unequal service based on money. These systems favor those who have large sums of money while those without the money struggle to get their message heard. The America's Political Communication System is designed to allow those without large sums of money to have access to their elected official as well as providing a means for two-way communications, allowing the elected official to communicate back. The System allows complex conceptual communication. Survey done today based on the results of a survey done yesterday continued over a period of time is no longer a survey but a dialogue. The America's Political Communication System reconnects the American citizen with their elected officials. As Thomas Jefferson said, “Equal Access, Equal Service.”

The America's Political Communication System is an improvement over the current systems of communication as it allows for quicker, cheaper and more efficient communications. It allows people equal access that is not based on money. It will give politicians a clear and instantaneous picture of what is on the voter's minds as well as allowing the politician to communicate back to the people.

1. Field of the Invention

U.S. Class 395-615: 395-600

2. Description of Related Art Including Information Disclosed Under 37 CFR §1.97** > and 1.98<.

### SUMMARY OF THE INVENTION

The invention consists a process for communication between people and businesses, nonprofit organizations and politicians or governmental officials. The process consists of an American Political Communication System which allows for complex conceptual communication. People would initiate this process by sending communications and data to the American Political Communications System. People would use some type of network interface consisting of either a personal computer, direct-line terminal or some other means to send communication or data to the American Political Communications System. The American Political Communications System would have numerous means in which it can communicate with the network interfaces. These means include but are not limited to telecommunications ports, direct lines, network and Internet connections. Each Person would have and be limited to access to a single electronic lockbox that would contain their demographic and personal data. The single lockbox limitation is to make sure that each person's will get only a single input/response/vote. The information or data sent from the People would be then processed through a data filter. The data filter will convert the persons individual communication or data into a collective view. This data filter will remove all individual identification and replace it with a key unique to that person. The collective view database utilizes Info Secure Communication Technology that protects the person's identity and allows the communications to be categorized. The person's communication and data is combined with other people's communication and data in the collective view database that facilitates communication. This communication and data reply can either be viewed by, transmitted to or be downloaded by the appropriate politician, business or nonprofit organization.

The politician, business or nonprofit can respond to the communication or data. The communication will go through the collective view database to the Data Filter where the key will be reconvert back to the person's individual data and loaded in their lockbox transmissions to or download by them.

The communication between the people, business, non-profits and politicians can be in form of a survey or a response to a survey or a free formatted data. The American Political Communication System will sort, categorize and collect the communications or data and get that communications or data to the proper party. Politicians can communicate with their constituents. Non-Profits can communication with their members or contributors. Businesses can communication with their customers, employees and shareholders. This communication can be used for electronic commerce and/or business transactions.

The lockbox can also be used by people, businesses, non-profits and politicians to store data. This data storage would be in the secured environment and could be temporary or permanent. This data would be stored until removed by the people, businesses, non-profits and politicians that placed it there.

### BRIEF DESCRIPTION OF THE DRAWINGS

Without restricting the full scope of this invention, the preferred form of this invention are illustrated in the following drawings

FIG. 1 is an overview of the American Political Communication System. It lays out how the communication and data flows from the People to the American Political Communication System and from the American Political Communication System to the Politicians, Businesses and Nonprofit Organizations. Network Interfaces are used to connect the People to the American Political Communications System. This communication and data flow is the same for Nonprofit Organizations, Politicians and Businesses. The communication and data flow to People, Nonprofit Organization, Politician and Business can be done over the Internet.

FIG. 2 shows how the flow of data and communication goes from People to the American Political Communication System where it is gathered, collected and forwarded on to the appropriate Politician, Nonprofit Organizations and Businesses.

FIG. 3 demonstrates how data and communications flow into the American Political Communication System to the Lockbox, which contains the demographic and personal data. The data and communications pass through the Data Filter which replaces the People's individual identifiers with a key, summaries and categorizes the data and communication which is passed to Collective View Database and then to the appropriate receiver.

FIG. 4 demonstrates how data and communications flows from the Business, Politician and Non-Profit Organization into the American Political Communication System to the Collective View Database. The data and communications pass through the Data Filter which matches the key with the People's individual identifiers and passes the data and communication to the Lockbox and then to the appropriate People.

FIG. 5 demonstrates how data and communications including responses are forwarded from the Politicians, Business or Nonprofit Organization to the American Political Communications System were it is gathered, collected and forwarded to the appropriate People

FIG. 6 displays the Secure Area.

### DESCRIPTION OF THE PREFERRED EMBODIMENT(S)

The current invention utilizes the Internet. The Internet comprises a vast number of computers and computer networks that are interconnected through communication links. The interconnected computers exchange information using various services, such as electronic mail, Gopher and the World Wide Web (“WWW”). The WWW service allows a server computer system (i.e., Web server or Webpage) to send graphical Webpages of information to a remote client computer system. The remote client computer system can then display the Webpages. Each resource (e.g., computer or Webpage) of the WWW is uniquely identifiable by a Uniform Resource Locator (“URL”). To view a specific Web page, a client computer system specifies the URL for that Web page in a request (e.g., a HyperText Transfer Protocol (“HTTP”) request). The request is forwarded to the Web server that supports that Webpage. When that Web server receives the request, it sends that Webpage to the client computer system. When the client computer system receives that Webpage, it typically displays the Web page using a browser. A browser is a special-purpose application program that affects the requesting of Web pages and the displaying of Webpages.

The Users can contact the a web site using an informational processing system capable of running an HTML compliant Web browser such as Microsoft's Internet Explorer, Netscape Navigator, Lynx and Mosaic. A typical system that is used is a personal computer with an operating system such as Windows 95, 98 or ME or Linux, running a Web browser. The exact hardware configuration of computer used by the users, the brand of operating system or the brand of Web browser configuration is unimportant to understand this present invention. Those skilled in the art can conclude that any HTML (Hyper Text Markup Language) compatible Web browser is within the true spirit of this invention and the scope of the claims.

The system 6 empowers individuals by providing them the power of a group or large organization. The system 6 focuses on the individual working with other who may be of a like mind, giving them the power of the group.

The system 6 is a type of mass communication system, so group or society can come together and communicate and work to achieve objectives. The unique part of the system 6 is that it is designed to work with the American system of government.

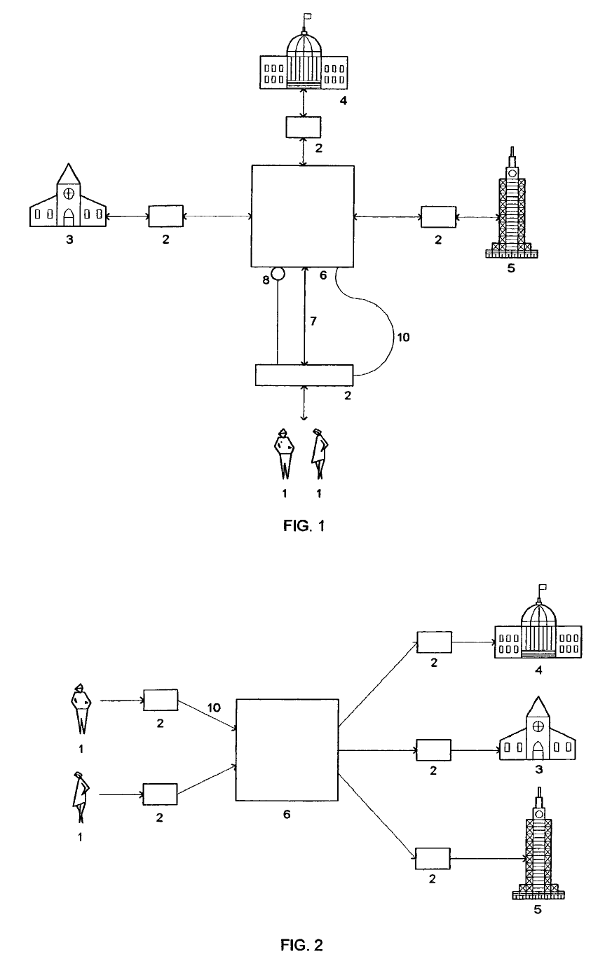

The American Political Communication System 6 in FIG. 1 consists of a Server System powerful enough to process the communication, database and data flowing through it. The American Political Communication System will have the optimal combination of dial-in telecommunications ports 8, direct connectivity 7 and Internet Connections 10. People 1 will use a Network Interface 2 consisting of a Personal Computer to connect to American Political Communication System 6 utilizing the Internet connection 10. Nonprofit Organizations 3 will use a Network Interface 2 consisting of a Personal Computer to connect to American Political Communication System 7 utilizing either a telecommunication port 8, direct line 7 or Internet connection 10. Politicians 4 will use a Network Interface 2 consisting of a Personal Computer to connect to American Political Communication System 7 utilizing either a telecommunication port 8, direct line 7 or Internet connection 10. Businesses 5 will use a Network Interface 2 consisting of a Personal Computer to connect to American Political Communication System 7 utilizing either a telecommunication port 8, direct line 7 or Internet connection 10.

The People 1 in FIG. 2 use their Network Interfaces 2 via the Telecommunication Port 8 and the Internet Connection 10 to send communications to the American Political Communication System 6. The American Political Communication System 6 sorts the communication, categorizes the data into the appropriate databases and forwards it on to the appropriate Politician 4, Business 5 or Nonprofit Organization 3. The Politician 4 uses their Network Interfaces 2 connected on a Direct Line 7 to receive the communication from the American Political Communication System 6. The Nonprofit Organization 3 uses its Network Interface 2 via the Telecommunications Port 8 to receive communications from the American Political Communication System. The Business 5 uses its Network Interface 2 via a Direct Line 7 to receive communications from the American Political Communication System.

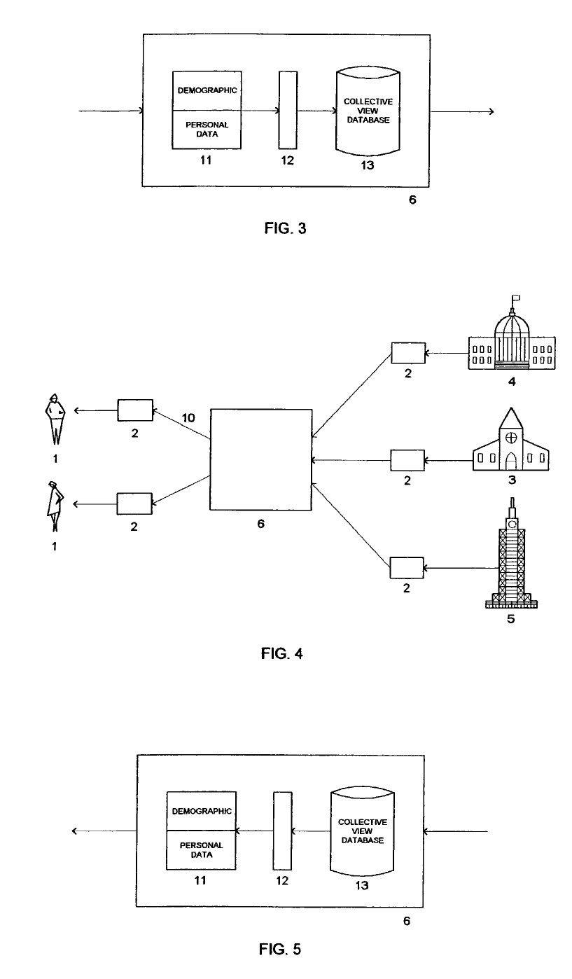

The American Political Communications System 6 in FIG. 3 will load the People 1 data or communication into that person's individual Lockbox 11. The Lockbox 11 is a secured database that contains a table that contains the identification keys of the individual users. The Lockbox 11 will contain that person's individual demographic and personal data. The data or communication will flow through the Data Filter 12. The Data Filter 12 will replace any individual identifiers with a key. This key will be matched to an individual user and will be contained within the lockbox. The data or communication will be passed to the Collective View Database 13 using Info Secure Communications Technology, which protects the person's, identity. The data will be categorized, sorted and forwarded on to the appropriate receiver.

The Politician 4, Business 5 and Nonprofit 3 in FIG. 4 use their Network Interfaces 2 connected on a Direct Line 7 to send their communications/responses to the American Political Communication System 6. The American Political Communication System 6 sorts the communication and forwards it on to the appropriate People. The People 1 in use their Network Interfaces 2 via the Telecommunication Port 8 and the Internet Connection 10 to send and receive the communications from the American Political Communication System 6.

The American Political Communications System 6 in FIG. 5 passes data to the Collective View Database 13 using Info Secure Communications Technology. The data will be categorized, sorted and forwarded on to the appropriate receiver. The data or communication will flow through the Data Filter 12. The Data Filter 12 will replace the key with the individual's identifier based on a secured key table in the lockbox database. The data or communication will be will loaded the People data or communication into the appropriate person's individual Lockbox 11.

The data collected can be gathered in the form of a survey. The results of the survey is used to generate information. In which the information is can be used to generate another survey. The survey and information cycle form a dialog between the people and politician(s). It is the summary of this information that is used to form the collective view. A view that can be viewed by everyone but still protect the identities of the users. This produces a society-wide communication system, which is a fundamental orientation shift from all other forms of communication from all other forms of communication as it allows the individual in the society to come together as a large group and then to act together as one entity to achieve an objective.

This communication back and forth creates an electronic conversation. As a conversation can that hundreds of back and forth comments or statements between people. The current invention always conversations on a much greater scale.

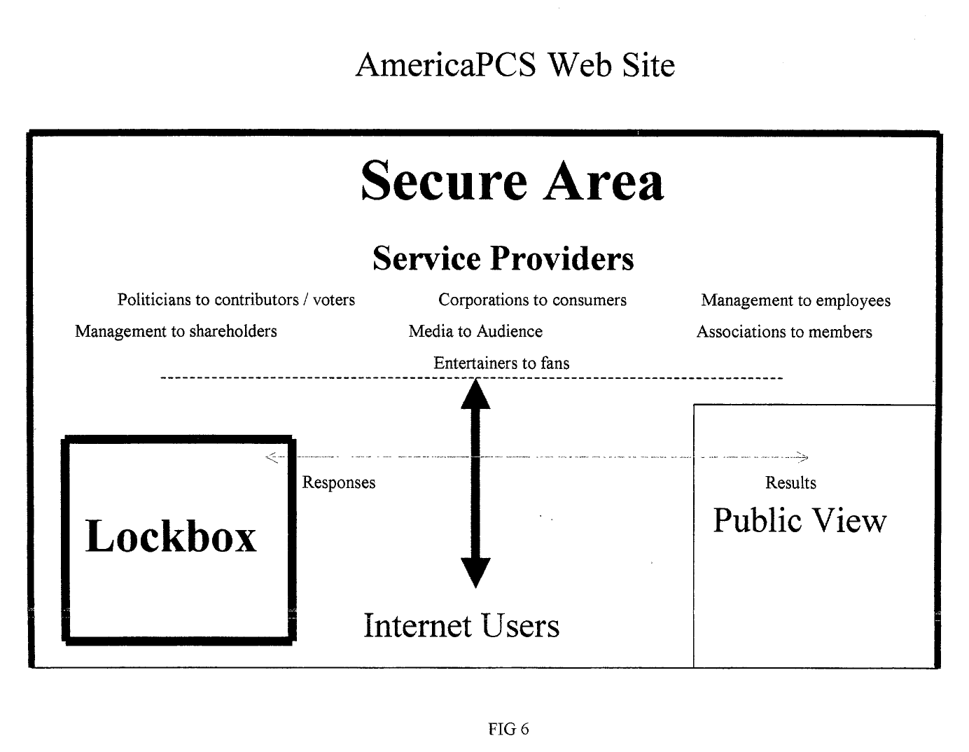

FIG. 6 shows the Secure Area of the System 6 where responses go to the Lockbox 11 from the Public/Collective View while results are reports from the Lockbox 11 to Public/Collective view while maintain the privacy of the individual user. The communication can be from politician to contributors/voter, management to shareholders, corporations to consumers, media to audience, entertainers to fans, management to employees, and association to members as well as other uses.

The data that is going back and for the on the system 6 can be streaming images, thus allowing for an interactive video conversation such as video television.

Conclusion, Ramifications, and Scope

With the need to have a communication system that empowers the individual by providing them the power of the group, the current invention provides such a communication means.

Although the present invention has been described in considerable detail with reference to certain preferred versions thereof, other versions are possible. For example, the system could be intranet or wan based, a protocol could be used or it could be use for another type of function. Therefore, the point and scope of the appended claims should not be limited to the description of the preferred versions contained herein.

That which is claimed:

1. A communication process comprising:
a) Communication between people and politicians with people using a communication means to a processing system to transmit and convey data to politicians through a communication means.
b) Communication between politicians and people with politicians using a communication means to a processing system to transmit and convey data to people through a communication means.

2. The communication process according to claim 1.
a) in which the processing system gathers, collects and forwards from people or a number of people on to the appropriate politician or politicians.
b) in which the processing system gathers, collects and forwards from a politicians or a number of politicians on to the appropriate people.

3. The communication process according to claim 1:
a) in which the processing system gathers, collects and forwards from a people or a number of people on to the appropriate politician or politicians.
b) in which the people and politicians can be a plurality of people, businesses, politicians or non-profit organizations.
c) In which the data gathered is in the form of a survey.

4. The communication process according to claim 1:
a) in which the processing system gathers, collects and forwards from a people or a number of people on to the appropriate politician or politicians.
b) in which the people and politicians can be a plurality of people, businesses, politicians or non-profit organizations.
c) In which the data can be stored by people or politicians.

5. The communication process according to claim 1:
a) in which the processing system gathers, collects and forwards from a people or a number of people on to the appropriate politician or politicians.
b) in which the people and politicians can be a plurality of people, businesses, politicians or non-profit organizations.
c) In which the data gathered is in the form of a survey.
d) In which the results of the survey is used to generate information.
e) In which the information is used to generate another survey.

6. A communication process comprising:
a) in which the processing system gathers, collects and forwards from a people or number of people on to the appropriate politician or politicians.
b) in which the processing system gathers, collects and forwards from a politicians or a number of politicians on to the appropriate people.
c) The communication means consists of a computer processing means with a combination of any number of dial-in telecommunications ports, direct connectivity and Internet connections or some type of interface means.
d) The people will use a network interface consisting of a computer processing means to transmit data to American Political Communication System consisting of a processing means utilizing either the a direct connectivity, dial-in, internet connection or some type of interface means.
e) The politician will use a network interface consisting of a computer processing means to receive data from the American Political Communication System utilizing either the a direct connectivity, dial-in, internet connection or some type of interface means.
f) The politician will use a network interface consisting of a computer processing means to transmit a reply to American Political Communication System utilizing either the a direct connectivity, dial-in, internet connection or some type of interface means.
g) The people will use a network interface consisting of a computer processing means to receive the reply from the American Political Communication System utilizing either the a direct connectivity, dial-in, internet connection or some type of interface means.

7 The communication process according to claim 6:
a) in which the people and politicians can be a plurality of people, businesses, politicians or non-profit organizations.

8. The communication process according to claim 6.
a) in which the people and politicians can be a plurality of people, businesses, politicians or non-profit organizations.
b) In which the user and receiver can store data on the system.

9. The communication process according to claim 6:
a) in which the data is in a form of streaming video

10. The communication process according to claim 6:
a) in which the people and politicians can be a plurality of people, businesses, politicians or non-profit organizations.
b) In which the data gathered is in the form of a survey.

11. The communication process according to claim 6:
a) in which the people and politicians can be a plurality of people, businesses, politicians or non-profit organizations.
b) In which the data gathered is in the form of a survey.
c) In which the results of the survey is used to generate information.
d) In which the information is used to generate another survey.

12. The communication process according to claim 6:
a) The American Political Communications System consisting of a processing means will load the data into a Lockbox. The Lockbox will contain that people's individual demographic and personal data.
b) The data will flow through a data filter. The data filter will replace any individual identifiers with a key.
c) The data will be passed to a database.
d) The database will use information security means which protects the people's identity.
e) The data will be categorized, sorted and forwarded on to the appropriate politician.
f) In which the people and politician can store data on the system.
g) In which the data can be see by all people or peoples and politician or politicians or a subset of all people or peoples and politician or politicians.
h) In which the people and politicians can be a plurality of people, businesses, politicians or non-profit organizations.

13. The communication process according to claim 6:
a) The American Political Communications System consisting of a processing means will load the data into a Lockbox. The Lockbox will contain that people's individual demographic and personal data.
b) The data will flow through a data filter. The data filter will replace any individual identifiers with a key.
c) The data will be passed to a database.
d) The database will use information security means which protects the people's identity.
e) The data will be categorized, sorted and forwarded on to the appropriate politician.
f) In which the people and politician can store data on the system.
g) In which the data can be see by all people or peoples and politician or politicians or a subset of all people or peoples and politician or politicians.
h) In which the people and politicians can be a plurality of people, businesses, politicians or non-profit organizations.
i) In which the data gathered is in the form of a survey

14. The communication process according to claim 6:
a) The American Political Communications System consisting of a processing means will load the data into a Lockbox. The Lockbox will contain that people's individual demographic and personal data.
b) The data will flow through a data filter. The data filter will replace any individual identifiers with a key.
c) The data will be passed to a database.
d) The database will use information security means which protects the people's identity.
e) The data will be categorized, sorted and forwarded on to the appropriate politician.
f) In which the people and politician can store data on the system.
g) In which the data can be see by all people or peoples and politician or politicians or a subset of all people or peoples and politician or politicians.
h) In which the people and politicians can be a plurality of people, businesses, politicians or non-profit organizations.
i) In which the data gathered is in the form of a survey
j) In which the results of the survey is used to generate information.
k) In which the information is used to generate another survey.

15. A communication process comprising:
a) in which the American Political Communication System consists of a computer processing means with a combination of any number of dial-in telecommunications ports, direct connectivity and internet connections
b) A user will use a network interface consisting of a computer processing means to transmit data to American Political Communication System utilizing either the a direct connectivity, dial-in, internet connection or some type of interface means.
c) The American Political Communication System sorts and categorizes the data and forwards it on to the appropriate receiver.
d) The American Political Communications System will load the data into a Lockbox. The Lockbox will contain that user's individual demographic and personal data.
e) The data will flow through a data filter. The data filter will replace any individual identifiers with a key.
f) The data will be passed to a Collective View Database.
g) The Collective View Database will use information security means which protects the user's identity.
h) The data will be categorized, sorted and forwarded on to the appropriate receiver.
i) In which the data can be see by all people or peoples and politician or politicians or a subset of all people or peoples and politician or politicians.
j) The receiver will use a network interface consisting of a computer processing means to receive data from the American Political Communication System utilizing either the a direct connectivity, dial-in, internet connection or some type of interface means.
k) The receiver will use a network interface consisting of a computer processing means to send a reply or data to the American Political Communication System utilizing either the a direct connectivity, dial-in, internet connection or some type of interface means.
l) The American Political Communication System sorts and categorizes the data and forwards it on to the appropriate user.
m) The American Political Communications System will load the data into a Lockbox. The Lockbox will contain that user's individual demographic and personal data.
n) The data will flow through a data filter. The data filter will replace any individual identifiers with a key.
o) The data will be passed to a Collective View Database.
p) The Collective View Database will use information security means which protects the user's identity.
q) The data will be categorized, sorted and forwarded on to the appropriate user
r) In which the data can be see by all people or peoples and politician or politicians or a subset of all people or peoples and politician or politicians.
s) The user will use a network interface consisting of a computer processing means to receive data from the American Political Communication System utilizing either the a direct connectivity, dial-in, internet connection or some type of interface means.

16. The communication process according to claim 15:
a) in which the user and receiver can be a plurality of people, businesses, politicians or non-profit organizations.

17. The communication process according to claim 15:
a) in which the user and receiver can be a plurality of people, businesses, politicians or non-profit organizations.
b) In which the data gathered is in the form of a survey.

18. The communication process according to claim 15.
a) in which the user and receiver can be a plurality of people, businesses, politicians or non-profit organizations.
b) In which the user and receiver can store data on the system.

19. The communication process according to claim 15.
a) in which the user and receiver can be a plurality of people, businesses, politicians or non-profit organizations.
b) in which the data is used for business transactions.

20. The communication process according to claim 15:
a) in which the user and receiver can be a plurality of people, businesses, politicians or non-profit organizations.
b) In which the data gathered is in the form of a survey.
c) In which the results of the survey is used to generate information.
d) In which the information is used to generate another survey.
